(19) United States
(12) Patent Application Publication
(10) Pub. No.: US 2013/0148951 A1
(43) Pub. Date: Jun. 13, 2013

(54) HOLDING DEVICE FOR CAMERA AND CAMERA DEVICE HAVING THE SAME

(71) Applicant: Shenzhen AEE Technology CO., LTD, Shenzhen (CN)

(72) Inventor: Xianzhi ZHANG, Shenzhen (CN)

(73) Assignee: SHENZHEN AEE TECHNOLOGY CO., LTD, Shenzhen (CN)

(21) Appl. No.: 13/693,064

(22) Filed: Dec. 4, 2012

(30) Foreign Application Priority Data
Dec. 13, 2011 (CN) 201110414058.7

(51) Int. Cl. G03B 17/00

(52) U.S. Cl. CPC G03B 17/00
USPC 396/428

(57) ABSTRACT

A holding device for a camera includes a base and an inserting member; the base includes a limiting slot and a first wire slot formed on a bottom portion of the limiting slot; the inserting member is inserted to the limiting slot to engage with the limiting slot; the inserting member includes a second wire slot formed on a side thereof which contacts the limiting slot, and the second wire slot engages with the first wire slot after the inserting member is inserted into the limiting slot to engage with the limiting slot. The holding device of the present disclosure not only allows a user to mount a camera to hamlets, walls, or planes, but also avoids the situation where the whole holding device needs to be replaced when one of the above components is damaged.

### BACKGROUND

1. Technical Field

The present disclosure relates to cameras and, particularly, to a holding device for a camera and a camera device having the same.

2. Description of Related Art

With the development of technology, cameras are commonly used. At present, cameras are powerful and can be used for different purposes. However, the present camera cannot be fixed to a user when necessary, thus, the user has to take pictures by holding the camera at hand. However, in some special situations, for example, when the user is climbing mountains, doing mining jobs, or driving a car, holding the camera by hand may be troublesome or dangerous. Although there are some holding devices can be used for holding the camera, if the user want to operate the camera after the camera is held in the holding device, the user has to detach the camera as well as the holding device away from the mounting point for operating the camera, which is inconvenient for the user to use the camera. Additionally, it is difficult to dissemble the components of the holding device.

### SUMMARY

The present disclosure provides a holding device for holding a camera which allows a user to operate the camera without detaching the whole holding device from a mounting point.

A holding device for a camera includes a base and an inserting member; the base includes a limiting slot and a first wire slot formed on a bottom portion of the limiting slot; the inserting member is inserted to the limiting slot to engage with the limiting slot; the inserting member includes a second wire slot formed on a side thereof which contacts the limiting slot, and the second wire slot engages with the first wire slot after the inserting member is inserted into the limiting slot to engage with the limiting slot.

Preferably, the holding device further includes a connecting member, a rotating member, and a mounting member; one end of the connecting member is connected to the inserting member and the other end thereof is connected to one end of the rotating member, the other end of the rotating member is connected to the mounting member; a number of protrusions are formed on the rotating member and a number of recessions respectively corresponding to the protrusions are formed in the mounting member.

Preferably, the connecting member forms at least one first receiving portion, the rotating member forms at least one second receiving portion engaging with the at least one first receiving portion; a first connecting hole is defined in each wall of the at least one first receiving portion and a second connecting hole is defined in each wall of the at least one second receiving portion; the holding device further includes a screw bolt being inserted into the first connecting hole and the second connecting hole and running through the at least one first receiving portion and the at least one second receiving portion to connect the connecting member and the rotating member; and the rotating member and the connecting member are capable of rotating around the screw bolt.

Preferably, a sucker, or a hook-and-loop fastener, or glue is arranged on one surface of the base opposite to the surface on which the limiting slot is arranged.

Preferably, a fixing hole is defined in the base, and the holding device further includes a bandage capable of passing through the fixing hole to fix the holding device.

The present disclosure further provides a camera device including a camera and a holding device for the camera. The holding device includes a base and an inserting member. The holding device includes a base and an inserting member; the base includes a limiting slot and a first wire slot formed on a bottom portion of the limiting slot; the inserting member is inserted to the limiting slot to engage with the limiting slot; the inserting member includes a second wire slot formed on a side thereof which contacts the limiting slot, and the second wire slot engages with the first wire slot after the inserting member is inserted into the limiting slot to engage with the limiting slot.

Preferably, the camera device further includes a connecting member, a rotating member, and a mounting member; one end of the connecting member is connected to the inserting member and the other end thereof is connected to one end of the rotating member, the other end of the rotating member is connected to the mounting member; a number of protrusions are formed on the rotating member and a number of recessions respectively corresponding to the protrusions are formed in the mounting member.

Preferably, the connecting member forms at least one first receiving portion, the rotating member forms at least one second receiving portion engaging with the at least one first receiving portion; a first connecting hole is defined in each wall of the at least one first receiving portion and a second connecting hole is defined in each wall of the at least one second receiving portion; the holding device further includes a screw bolt being inserted into the first connecting hole and the second connecting hole and running through the at least one first receiving portion and the at least one second receiving portion to connect the connecting member and the rotating member; and the rotating member and the connecting member are capable of rotating around the screw bolt.

Preferably, a sucker, or a hook-and-loop fastener, or glue is arranged on one surface of the base opposite to the surface on which the limiting slot is arranged.

Preferably, a fixing hole is defined in the base, and the holding device further includes a bandage capable of passing through the fixing hole to fix the holding device.

The base, the inserting member, the connecting member, the rotating member, and the mounting member of the holding device are detachably mounted to each other, which not only allows a user to mount a camera to hamlets, walls, or planes, but also avoids the situation where the whole holding device needs to be replaced when one of the above components is damaged. This eases the replacements of the components and reduces production cost and using cost of the camera. Additionally, since the inserting member and the base are lockably engaged, the user can operate the camera without taking the holding device away from the mounting point. Furthermore, the connecting member and the rotating member are rotatably connected together, thereby allowing the camera to take pictures from various angles which can be fixed by using the screw bolt.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a holding device for a camera in accordance with an embodiment of the present disclosure;

FIG. 2 is a schematic view of a base of the holding device of FIG. 1;

FIG. 3 is a partially enlarged view of the base of FIG. 2;

FIG. 4 is a schematic view showing the assembly of the assembly of an inserting member and a connecting member of the holding device of FIG. 1;

FIG. 5 is an exploded view of FIG. 4;

FIG. 6 is a schematic view of the connecting member of FIG. 4;

FIG. 7 is a schematic view of a rotating member of the holding device of FIG. 1 in accordance with one embodiment;

FIG. 8 is a schematic view of the rotating member in accordance with another embodiment.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

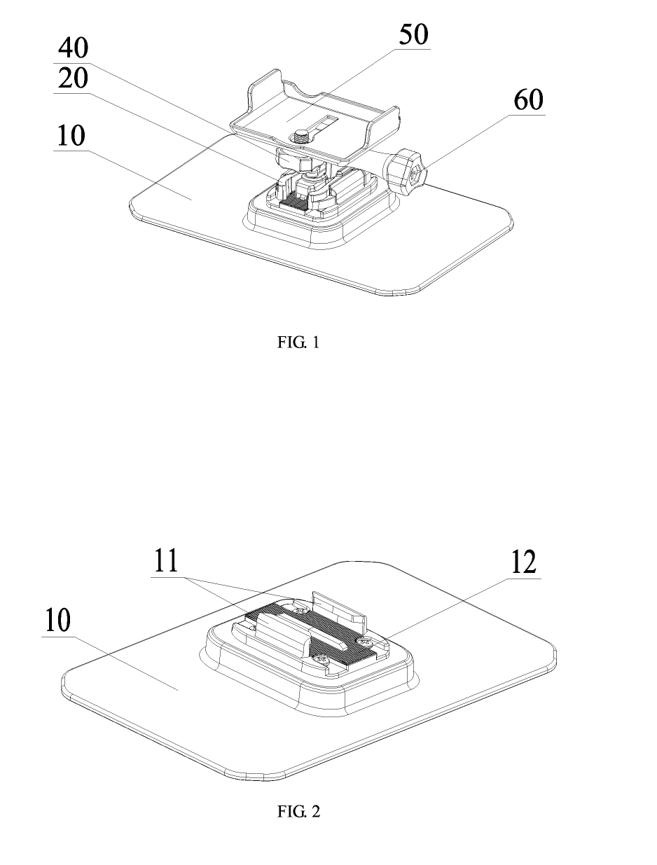

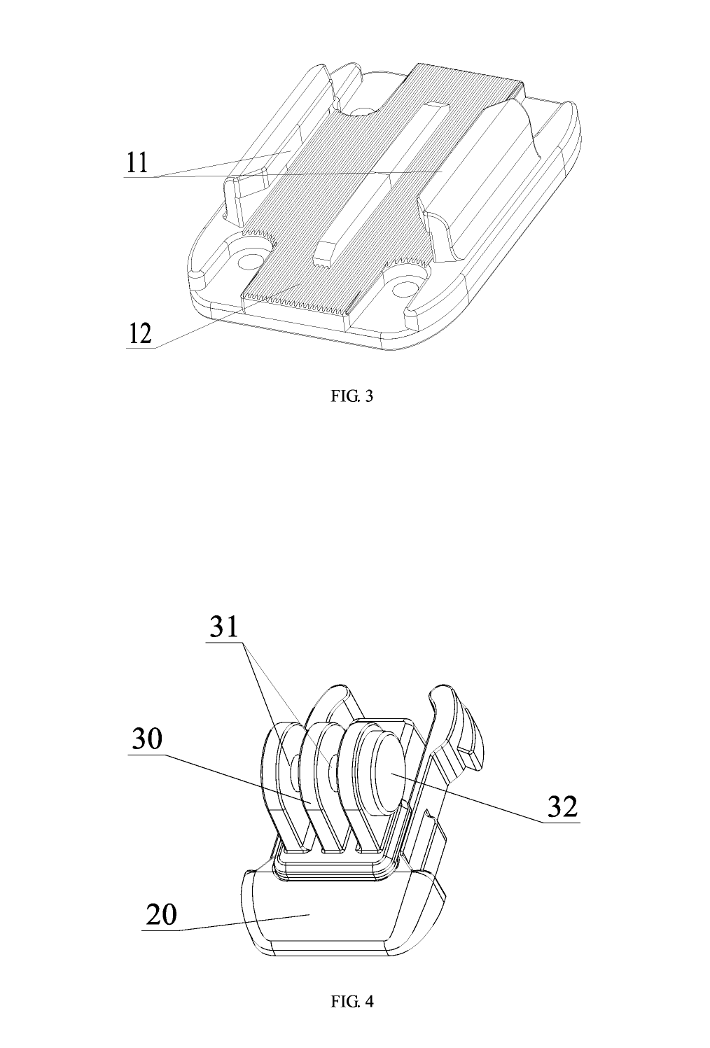

Referring to FIGS. 1 to 3, in which FIG. 1 is a schematic view of a holding device for a camera in accordance with an embodiment of the present disclosure, FIG. 2 is a schematic view of a base of the holding device of FIG. 1, and FIG. 3 is a an partially enlarged view of the base.

The holding device for a camera includes a base 10, an inserting member 20, a connecting member 30, a rotating member 40, a mounting member 50, and a screw bolt 60. A limiting slot 11 engageable with the inserting member 20 is arranged on an upper surface of the base 10. A first wire slot structure 12 is formed on the bottom portion of the limiting slot 11 and a second wire slot structure (not shown in the drawing) corresponding to the first wire slot structure 12 is formed on a side of the inserting member 20 which contacts the limiting slot 11. After the inserting member 20 is inserted into the limiting slot 11, the first wire slot structure 12 engages with the second wire slot structure. With the engagement between the first wire slot structure 12 formed on the base 10 and the second wire slot structure formed on the inserting member 20, the situation where the inserting member 20 scratches the product surface can be avoided and the process of inserting the inserting member 20 to the limiting slot 11 is smoothened. Furthermore, the inserting member 20 can be provided with elastic hooks (not shown in the drawing) on two sides thereof. After the inserting member 20 is inserted into the limiting slot 11, the hooks can be hooked onto the limiting slot 11 to prevent the inserting member 20 from dropping from the limiting slot 11 and thus stably connect the inserting member 20 to the base 10. As shown in FIG. 1, the screw bolt 60 is a long screw blot which can be operated without using tools. Due to the increased length of the screw blot 60, the stress surface and the friction of the screw blot 60 are correspondingly increased, allowing the screw bolt 60 to be harder tightened.

The present disclosure allows a user to operate the camera without taking the holding device away from a mounting point. Specifically, the user can at first detach the inserting member 20 from the base 10 before operating the camera and mount the inserting member 20 onto the base 10 after using the camera.

Referring to FIGS. 4 and 5, in which FIG. 4 is a schematic view showing the assembly of the inserting member and the connecting member, and FIG. 5 is an exploded view of FIG. 4.

One end of the connecting member 30 is detachably mounted to the inserting member 20. At least one through hole 21 is defined in the inserting member 20 and at least one screw hole (not shown in the drawing) corresponding to the through hole 21 is defined in the connecting member 30. Screws 70 are used to insert into the through hole 21 and the screw hole for connecting the inserting member 20 and the connecting member 30. In order to stabilize the assembly of the inserting member 20 and the connecting member 30, the numbers of the through hole and the screw hole are preferably respectively three.

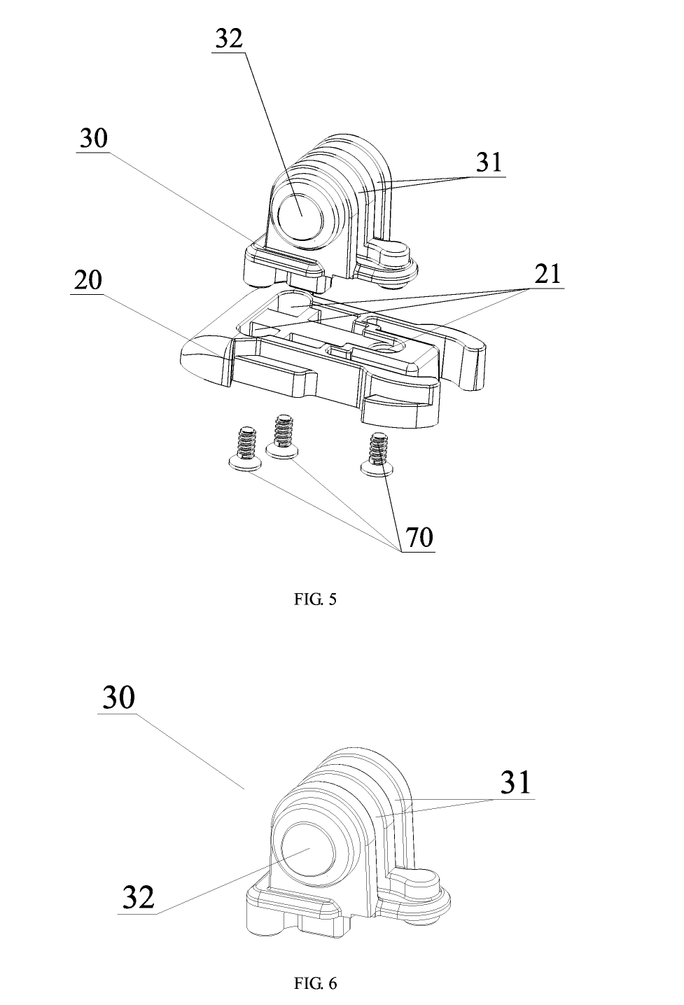

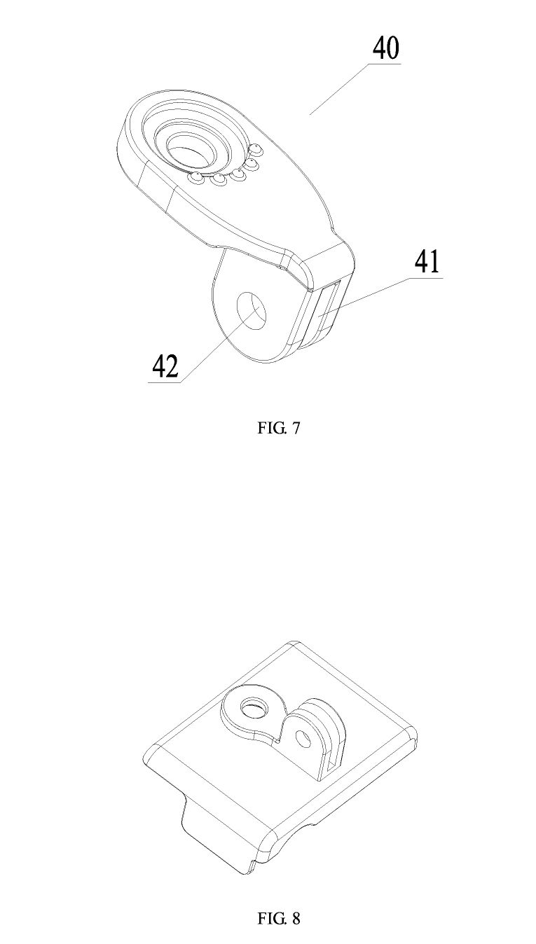

Referring to FIGS. 6 and 7, in which FIG. 6 is a schematic view of the connecting member 30 in accordance with an embodiment of the present disclosure, and FIG. 7 is a schematic view of the rotating member 40 in accordance with an embodiment of the present disclosure.

The other end of the connecting member 30 is rotatably connected to the rotating member 40. At least one first receiving portion 31 is formed in the connecting member 30 and at least one second receiving portion 41 is formed in the rotating member 40 for engaging with the at least one first receiving portion 31. Each wall of the first receiving portion 31 defines a first connecting hole 32 and each wall of the second receiving portion 41 defines a second connecting hole 42 corresponding to the first connecting hole 32. The diameter of the first connecting hole 32 is equal to that of the second connecting hole 42, both which is greater than the diameter of the screw bolt 60. As shown in FIG. 1, the screw blot 60 is inserted into the first through holes 32 and the second through holes 42 to run through the first receiving portion 31 and the second receiving portion 41, thereby connecting the connecting member 30 and the rotating member 40. The connecting member 30 and the rotating member 40 can rotate around the screw 60.

In the embodiment, the number of the first receiving portion 31 formed in the connecting member 30 is preferably two and the number of the second receiving portion 41 formed in the rotating member 40 is preferably one.

The screw blot 60 in the embodiment may include a screw and a nut. The screw is connected to the nut after running through the first receiving portion 31 and the second receiving portion 41. By using the screw and the nut, the connecting degree between the first receiving portion 31 and the second receiving portion 41 can be adjusted. After the angle between the rotating member 40 and the connecting member 30 is adjusted, the screw bolt 60 can be tightened to tightly connecting the first receiving portion 31 and the second receiving portion 41. In this way, the rotating angle of the rotating member 40 can be fixed to stabilize the connection between the rotating member 40 and the connecting member 30 and to avoid movement and swaying of the rotating member 40.

The walls of the first receiving portion 31 and the second receiving portion 41 are respectively arc shaped, which eases the rotation of the first receiving portion 31 and the second receiving portion 41. The first receiving portion 31 and the second receiving portion 41 are engaged with each other, for example, the walls of the first receiving portion 31 are received in the second receiving portion 41 and the walls of the second receiving portion 41 are received in the first receiving portion 31. Additionally, the width of the first/second receiving portion is greater than the thickness of the wall of the second/first receiving portion, which allows the first receiving portion 31 to rotate relative to the second receiving portion 41 smoothly and avoids movement and swaying in the rotation. The connecting member 30 of the holding device of the present disclosure is rotatable relative to the rotating member 40 to allow the camera to take pictures from various angles.

As shown in FIG. 6, a number of protrusions are formed on the rotating member 40 and a number of recessions respectively corresponding to the protrusions are defined in the mounting member 50. The protrusions and the recessions can respectively engage with each other during the process of rotately connecting the rotating member 40 to the mounting member 50. Since the distance between two adjacent protrusions is short and the contacting area between each protrusion and the mounting member 50 is also small, the protrusions can respectively slide into the recessions easily under the force used for rotately connecting the rotating member 40 to the mounting member 50. With the protrusions and the recessions engageable with the protrusions, the camera can be stably held in the holding device.

Referring to FIG. 1 again, the other end of the rotating member 40 is connected to the mounting member 50 via a screw bolt. The mounting member 50 is half opened and is shaped corresponding to the bottom portion of a camera. The side walls of the mounting member 50 can be respectively curved inwards for clamping the camera, thus, the holding device can hold the camera stably. It is noted that the mounting member 50 is not limited to this embodiment and can be modified according to the shape of the camera.

Referring to FIG. 8, the rotating member in accordance with another embodiment of the present disclosure, is schematically shown. In the embodiment, the rotating member can function as the rotating member 40 and the mounting member 50 in the embodiment described above and is connected to the connecting member 30 for holding the camera.

In the embodiment, a sucker (not shown in the drawing) or Velcro (not shown in the drawing) can be arranged on a lower surface (the surface opposite to the surface on which the limiting slot is formed) of the base. In this way, the holding device can be connected to smooth surfaces such as wall surfaces, glass surfaces, tops of tables, and hamlets, or can be connected to the user directly.

In the above embodiment, the base 10 can further define a fixing hole (not shown in the drawing) and the holding device can further include a bandage (not shown in the drawing) for fixing a camera. The bandage is capable of passing through the fixing hole and fixing the camera in combination with the sucker or the Velcro mentioned above to hamlets or the user. With the bandage, the holding device of the camera can be fixed more stably. It is noted that the bandage can be used with the omission of the sucker or the magic sticker.

The present disclosure further provides a camera device including a camera and the holding device for holding the camera described in the above embodiment.

The holding device of the present disclosure can be used for mounting a camera to hamlets, walls, or planes. The base 10, the inserting member 20, the connecting member 30, the rotating member 40, and the mounting member 50 of the holding device are detachably mounted to each other, thus, the situation where the whole holding device needs to be replaced when one of the above components is damaged can be avoided. This eases the replacements of the components and reduces production cost and using cost of the camera. Additionally, since the inserting member 20 and the base 10 are lockably engaged, the user can operate the camera without taking the holding device away from the mounting point. Furthermore, the connecting member and the rotating member are rotatably connected together, thereby allowing the camera to take pictures from various angles which can be fixed by using the screw bolt 60.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A holding device for a camera, comprising:
a base comprising a limiting slot and a first wire slot formed on a bottom portion of the limiting slot; and
an inserting member being inserted to the limiting slot to engage with the limiting slot, the inserting member comprising a second wire slot formed on a side thereof which contacts the limiting slot, and the second wire slot engaging with the first wire slot after the inserting member is inserted into the limiting slot to engage with the limiting slot.

2. The holding device as claimed in claim 1 further comprising a connecting member, a rotating member, and a mounting member; one end of the connecting member is connected to the inserting member and the other end thereof is connected to one end of the rotating member, the other end of the rotating member is connected to the mounting member; a number of protrusions are formed on the rotating member and a number of recessions respectively corresponding to the protrusions are formed in the mounting member.

3. The holding device as claimed in claim 2, wherein the connecting member forms at least one first receiving portion, the rotating member forms at least one second receiving portion engaging with the at least one first receiving portion; a first connecting hole is defined in each wall of the at least one first receiving portion and a second connecting hole is defined in each wall of the at least one second receiving portion; the holding device further comprises a screw bolt being inserted into the first connecting hole and the second connecting hole and running through the at least one first receiving portion and the at least one second receiving portion to connect the connecting member and the rotating member; and the rotating member and the connecting member are capable of rotating around the screw bolt.

4. The holding device as claimed in claim 3, wherein a sucker, or a hook-and-loop fastener, or glue is arranged on one surface of the base opposite to the surface on which the limiting slot is arranged.

5. The holding device as claimed in claim 1, wherein a fixing hole is defined in the base, and the holding device further comprises a bandage capable of passing through the fixing hole to fix the holding device.

6. The holding device as claimed in claim 2, wherein a fixing hole is defined in the base, and the holding device further comprises a bandage capable of passing through the fixing hole to fix the holding device.

7. The holding device as claimed in claim 3, wherein a fixing hole is defined in the base, and the holding device further comprises a bandage capable of passing through the fixing hole to fix the holding device.

8. The holding device as claimed in claim 4, wherein a fixing hole is defined in the base, and the holding device further comprises a bandage capable of passing through the fixing hole to fix the holding device.

9. A camera device, comprising a camera and a holding device for the camera, the holding device comprising:
a base comprising a limiting slot and a first wire slot formed on a bottom portion of the limiting slot; and
an inserting member being inserted to the limiting slot to engage with the limiting slot, the inserting member comprising a second wire slot formed on a side thereof which contacts the limiting slot, and the second wire slot engaging with the first wire slot after the inserting member is inserted into the limiting slot to engage with the limiting slot.

10. The camera device as claimed in claim 9 further comprising a connecting member, a rotating member, and a mounting member; one end of the connecting member is connected to the inserting member and the other end thereof is connected to one end of the rotating member, the other end of the rotating member is connected to the mounting member; a number of protrusions are formed on the rotating member and a number of recessions respectively corresponding to the protrusions are formed in the mounting member.

11. The camera device as claimed in claim 10, wherein the connecting member forms at least one first receiving portion, the rotating member forms at least one second receiving portion engaging with the at least one first receiving portion; a first connecting hole is defined in each wall of the at least one first receiving portion and a second connecting hole is defined in each wall of the at least one second receiving portion; the holding device further comprises a screw bolt being inserted into the first connecting hole and the second connecting hole and running through the at least one first receiving portion and the at least one second receiving portion to connect the connecting member and the rotating member; and the rotating member and the connecting member are capable of rotating around the screw bolt.

12. The camera device as claimed in claim 11, wherein a sucker, or a hook-and-loop fastener, or glue is arranged on one surface of the base opposite to the surface on which the limiting slot is arranged.

13. The camera device as claimed in claim 9, wherein a fixing hole is defined in the base, and the holding device further comprises a bandage capable of passing through the fixing hole to fix the holding device.

14. The camera device as claimed in claim 10, wherein a fixing hole is defined in the base, and the holding device further comprises a bandage capable of passing through the fixing hole to fix the holding device.

15. The camera device as claimed in claim 11, wherein a fixing hole is defined in the base, and the holding device further comprises a bandage capable of passing through the fixing hole to fix the holding device.

16. The camera device as claimed in claim 12, wherein a fixing hole is defined in the base, and the holding device further comprises a bandage capable of passing through the fixing hole to fix the holding device.
